(19) United States
(12) Patent Application Publication
(10) Pub. No.: US 2015/0118502 A1
(43) Pub. Date: Apr. 30, 2015

(54) SILANE COMPOUND CONTAINING PERFLUOROPOLYETHER GROUP AND SURFACE-TREATING AGENT

(71) Applicant: DAIKIN INDUSTRIES, LTD., Osaka-shi, Osaka (JP)

(72) Inventors: Hisashi Mitsuhashi, Settsu-shi (JP); Akinari Sugiyama, Settsu-shi (JP)

(73) Assignee: DAIKIN INDUSTRIES, LTD., Osaka-shi, Osaka (JP)

(21) Appl. No.: 14/407,320

(22) PCT Filed: Jun. 12, 2013
(86) PCT No.: PCT/JP2013/066182

§ 371 Date: Dec. 11, 2014

(30) Foreign Application Priority Data
Jun. 13, 2012 (JP) 2012-133683

(51) Int. Cl. C09K 3/18; C09D 5/16; C07F 7/18

(52) U.S. Cl. CPC C09K 3/18; C07F 7/1836; C09D 5/1625
USPC 428/429; 556/448; 106/2; 428/447

(57) ABSTRACT

The present invention provides a novel perfluoropolyether group containing silane compound wherein the compound is represented by any one of the following general formulae (1a), (1b) (2a) and (2b), has a number average molecular weight of 6×10³ to 1×10⁵ and can form a layer having water-repellency, oil-repellency, antifouling repellency and high friction durability.

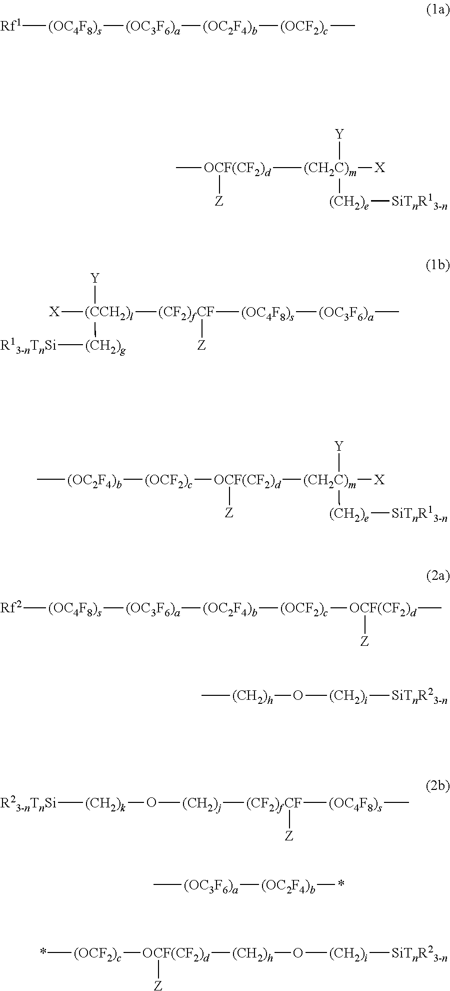

### TECHNICAL FIELD

The present invention relates to a perfluoropolyether group containing silane compound. The present invention also relates to a surface-treating agent and the like in which the perfluoropolyether group containing silane compound is used.

### BACKGROUND ART

A certain fluorine-containing silane compound is known to be able to provide excellent water-repellency, oil-repellency, antifouling property, or the like when it is used on a surface treatment of a base material. A layer (hereinafter, referred to as a “surface-treating layer”) formed from the surface-treating agent comprising a fluorine-containing silane compound is applied to various base materials such as a glass, a plastic, a fiber and a building material as a so-called functional thin film.

As such fluorine-containing silane compound, a perfluoropolyether group containing silane compound which has a perfluoropolyether group in its molecular main chain and a hydrolyzable group bonding to a Si atom in its molecular terminal or terminal portion is known (see Patent Literatures 1-2). When a surface-treating agent containing this perfluoropolyether group containing silane compound is applied to a base material, the hydrolyzable groups bonding to a Si atom react and bond with the base material and between the compounds to form a surface-treating layer.

### PRIOR ART LITERATURE

### Patent Literature

Patent Literature 1: WO 97/07155

Patent Literature 2: JP 2008-534696 A

### SUMMARY OF THE INVENTION

### Problem to be Solved by the Invention

The surface-treating layer is requested for high durability to provide a base material with a desired function for a long time. The layer formed from the surface-treating agent containing the perfluoropolyether group containing silane compound has been suitably used in an optical member such as glasses, touch panel or the like which is required to have light permeability or transparency since it can exert the above functions even in form of a thin film. In particular, in these uses, the friction durability is required to be further improved.

However, a layer formed from a surface-treating agent containing a conventional perfluoropolyether group containing silane compound is no longer necessarily enough to meet the increasing demand to improve the friction durability.

An object of the present invention is to provide a novel perfluoropolyether group containing silane compound which is able to form a layer having water-repellency, oil-repellency and antifouling repellency as well as high friction durability. An object of the present invention is also to provide a surface-treating agent and the like which are obtained by the use of the perfluoropolyether group containing silane compound.

### Means to Solve the Problem

According to one aspect of the present invention, there is provided a perfluoropolyether group containing silane compound which has a number average molecular weight of 6×10³ to 1×10⁵ and is represented by any one of the following general formulae (1a) and (1b):

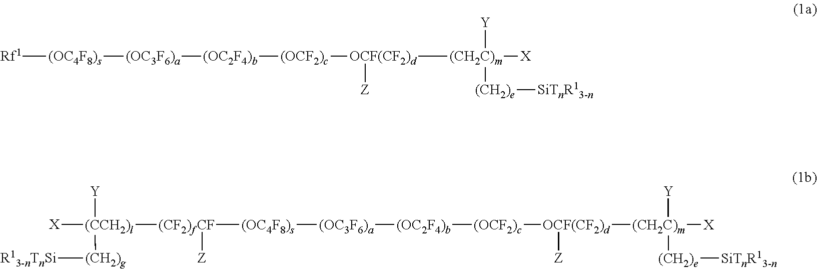

wherein:

Rf¹ is an alkyl group having 1 to 16 carbon atoms which may be substituted by one or more fluorine atoms;

a, b, c and s are each independently an integer of 0 or more and 200 or less, wherein the sum of a, b, c and s is 1 or more, and the occurrence order of the respective repeating units in parentheses with the subscript a, b, c or s is not limited in the formula;

d and f are 0 or 1;

e and g are an integer from 0 to 2;

m and l are an integer from 1 to 10;

X is a hydrogen atom or a halogen atom;

Y is a hydrogen atom or a lower alkyl group;

Z is a fluorine atom or a lower fluoroalkyl group;

T is a hydroxyl group or a hydrolyzable group;

R¹ is a hydrogen atom or an alkyl group having 1 to 22 carbon atoms; and

n is an integer from 1 to 3.

It is noted that when there are a plurality of the same symbols in a general formula, they are each independently selected throughout the present specification.

According to another aspect of the present invention, there is provided a perfluoropolyether group containing silane compound which has a number average molecular weight of 6×10³ to 1×10⁵ and is represented by any one of the following general formulae (2a) and (2b):

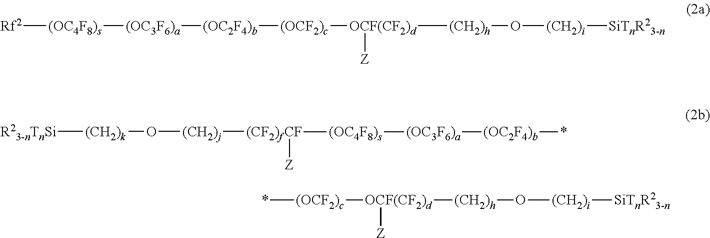

wherein:

Rf² is an alkyl group having 1 to 16 carbon atoms which may be substituted by one or more fluorine atoms;

a, b, c and s are each independently an integer of 0 or more and 200 or less, wherein the sum of a, b, c and s is 1 or more, and the occurrence order of the respective repeating units in parentheses with the subscript a, b, c or s is not limited in the formula;

d and f are 0 or 1;

h and j are 1 or 2;

i and k are an integer from 2 to 20;

Z is a fluorine atom or a lower fluoroalkyl group;

T is a hydroxyl group or a hydrolyzable group;

R² is a hydrogen atom or an alkyl group having 1 to 22 carbon atoms; and

n is an integer from 1 to 3.

According to further aspect of the present invention, there is provided a surface-treating agent comprising at least one perfluoropolyether group containing silane compound which has a number average molecular weight of 6×10³ to 1×10⁵ and represented by any one of the above general formulae (1a), (1b), (2a) and (2b) (hereinafter, also referred to as a “fluorine-containing silane compound of the present invention” as a representative thereof) or a mixture thereof.

The surface-treating agent of the present invention can provide water-repellency, oil-repellency, antifouling repellency, friction durability to a base material and may be suitably used as an antifouling-coating agent, but not particularly limited thereto.

According to further another aspect of the present invention, there is provided an article comprising a base material and a layer (surface-treating layer) which is formed from the above perfluoropolyether group containing silane compound or the above surface-treating agent. The layer in the article has water-repellency, oil-repellency and antifouling repellency as well as high friction durability.

The article obtained by the present invention is not particularly limited, but for example, may be an optical member. Since the optical member is highly demanded for the improvement of friction durability, the present invention may suitably be used therein. The above base material may be, for example, a glass or a transparent plastic. It is noted that the term “transparent” as used herein means, for example, that a haze value is 5% or less, but it has only to be recognized to be generally transparent.

### Effect of the Invention

According to the present invention, there is provided a novel perfluoropolyether group containing silane compound. This compound is characterized by having a number average molecular weight of 6×10³ to 1×10⁵, thereby, being able to form a layer having water-repellency, oil-repellency, antifouling repellency as well as high friction durability. Furthermore, according to the present invention, there is provided a surface-treating agent obtained by the use of the fluorine-containing silane compound of the present invention and an article to which they are applied.

### BRIEF DESCRIPTION OF THE DRAWINGS

FIG. 1 is a graph showing friction durability in the surface-treating layers formed in Examples 1-6 and Comparative Examples 1-3.

### EMBODIMENTS TO CARRY OUT THE INVENTION

Hereinafter, the fluorine-containing silane compound of the present invention, the surface-treating agent and the article produced by using it will be described in detail, although the present invention is not limited thereto.
A perfluoropolyether group containing silane compound having a number average molecular weight of 6×10³ to 1×10⁵

In one embodiment of the present invention, the fluorine-containing silane compound of the present invention is characterized by being represented by any one of the following general formulae (1a) and (1b) and has a number average molecular weight of 6×10³ to 1×10⁵.

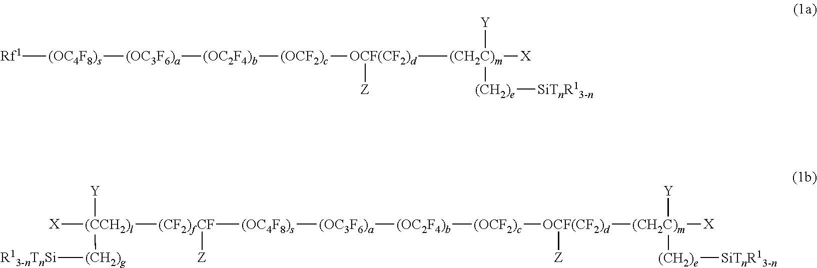

In another embodiment, the fluorine-containing silane compound of the present invention is characterized by being represented by any one of the general formula (2a) and (2b) and having the number average molecular weight of 6×10³ to 1×10⁵.

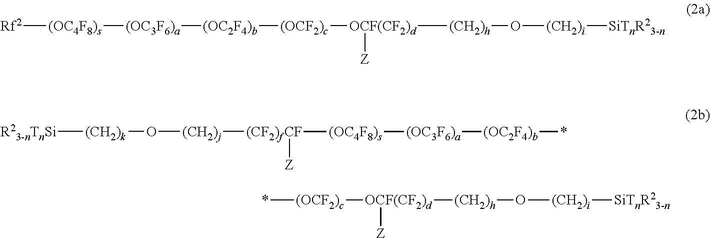

In these formulae, Rf¹ and Rf² are an alkyl group (for example, straight chain or branched chain) having 1 to 16 carbon atoms which may be substituted by one or more fluorine atoms, preferably a straight or branched alkyl group having 1 to 3 carbon atoms which may be substituted by one or more fluorine atoms. The alkyl group which may be substituted by one or more fluorine atoms is preferably an alkyl group in which a terminal carbon atom is CF₂H— and the other carbons are fully-substituted with fluorine atoms or a perfluoroalkyl group, more preferably a perfluoroalkyl group, specifically —CF₃, —CF₂CF₃ or —CF₂CF₂CF₃.

In the above formula, the perfluoropolyether group is a part represented by the following formula.

—(OC₄F₈)ₛ—(OC₃F₆)ₐ—(OC₂F₄)_{b}—(OCF₂)_{c}—

In this formula, “a” “b”, “c” and “s” represent the repeating number of each of four repeating units of perfluoropolyether which constitute a main backbone of the polymer, and are each independently an integer of 0 or more and 200 or less, for example 1 or more and 200 or less wherein the sum of “a”, “b”, “c” and “s” is one or more, preferably 20-100, more preferably 30-50, reprehensively about 40. The occurrence order of the respective repeating units in parentheses with the subscript “a”, “b”, “c” and “s” is not limited in the formulae. Among these repeating units, the —(OC₄F₈)— group may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF (C₂F₅) CF₂)— and —(OCF₂CF(C₂F₅))—, preferably —(OCF₂CF₂CF₂CF₂). The —(OC₃F₆)— group may be any of —(OCF₂CF₂CF₂)—, —(OCF(CF₃)CF₂)— and —(OCF₂CF(CF₃))—, preferably —(OCF₂CF₂CF₂)—. The —(OC₂F₄)— group may be any of —(OCF₂CF₂)— and —(OCF(CF₃))—, preferably —(OCF₂CF₂)—.

The compound having the perfluoropolyether group can exert antifouling repellency (for example, preventing from adhering a fouling such as fingerprints) in addition to excellent water-repellency and oil-repellency.

In the above formula, “d” and “f” are 0 or 1, and “e” and “g” are an integer of 0 or more and 2 or less.

In the above formula, “h” and “j” are 1 or 2, and “i” and “k” are an integer of 2 or more and 20 or less.

X is a hydrogen atom or a halogen atom. The halogen atom is preferably an iodine atom, a chlorine atom or a fluorine atom, more preferably an iodine atom.

Y is a hydrogen atom or a lower alkyl group. The lower alkyl group is preferably an alkyl group having 1 to 20 carbon atoms.

Z is a fluorine atom or a lower fluoroalkyl group. The lower fluoroalkyl group is, for example, a fluoroalkyl group having 1 to 3 carbon atoms, preferably a perfluoroalkyl group having 1 to 3 carbon atoms, more preferably a trifluoromethyl group, a pentafluoroethyl group, more preferably a trifluoromethyl group.

It is preferable that Rf¹ and Rf² are a perfluoroalkyl group having 1 to 3 carbon atoms, b=0, c=0, d=1 and f=1, and Z is a fluorine atom, although the present invention is limited thereto. In this case, suitable friction durability can be obtained. It is more preferable that the repeating unit —(OC₃F₆)— in parentheses with the subscript “a” is —(OCF₂CF₂CF₂)—, and a=40. In this case, the perfluoropolyether group has a straight chain structure. Such compound can provide higher friction durability than a compound having a branched chain structure, and has an advantageous to be easily prepared.

T, R¹ and R² are a group bonding to Si. A subscript “n” is an integer from 1 to 3.

R¹ and R² are an alkyl group having 1 to 22 carbon atoms, an alkoxy group having 1 to 22 carbon atoms or a hydroxyl group, preferably an alkyl group having 1 to 22 carbon atoms or an alkoxy group having 1 to 22 carbon atoms, more preferably an alkyl group having 1 to 3 carbons or an alkoxy group having 1 to 3 carbons. The hydroxyl group is not particularly limited, but may be that produced by the hydrolysis of the alkoxy group having 1 to 22 carbon atoms.

T is a hydroxyl group or a hydrolyzable group. Examples of the hydrolyzable group include —OA, —OCOA, —O—N═C(A)₂, —N(A)₂, —NHA, halogen (wherein A is a substituted or non-substituted alkyl group having 1-3 carbon atoms), and the like.

The subscripts “m” and “l” are an integer from 1 to 10. The subscripts “m” and “l” are preferably an integer from 2 to 6.

The fluorine-containing silane compound of the present invention represented by the above general formulae (1a) and (1b) and the above general formulae (2a) and (2b) has a number average molecular weight (hereinafter, referred to simply as “average molecular weight”) in the range of 6×10³ to 1×10⁵ since when the number average molecular weight is too low, high friction durability cannot be obtained, and when it is too high, a method for applying the compound on the base material is limited. The number average molecular weight is preferably 6×10³ to 3×10⁴, more preferably 7×10³ to 3×10⁴, further preferably 7×10³ to 1×10⁴, specifically about 8,000. The fluorine-containing silane compound of the present invention can provide high friction durability and be easily applied to the base material by having the number average molecular weight in the range thereof.

The fluorine-containing silane compound of the present invention represented by the above general formulae (1a), (1b), (2a) and (2b) may be a mixture of one or two or more compounds. In the mixture, each compound can be present at 1-99 weight %, but not limited thereto.

The above fluorine-containing silane compound of the present invention can be prepared by any suitable method. For example, the compound can be prepared by the following method, but not limited thereto.

For the fluorine-containing silane compound of the present invention represented by any one of the above general formulae (1a) and (1b), firstly, at least one compound of any one of the following general formulae (1a-ii) and (1b-ii) are provided as a raw material:

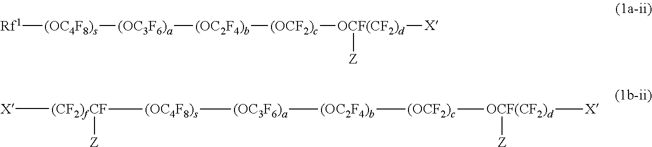

wherein:

X′ is a halogen atom, preferably an iodine atom, and the other symbols are as defined above. The compound can be prepared, for example, by the halogenation (for example, iodination) of at least one compound of any one of the following general formulae (1a-i) and (1b-i) but not limited thereto:

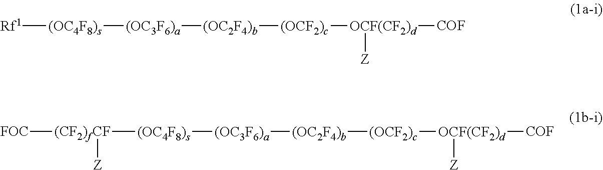

wherein each symbol is as defined above.

At least one compound of any one of the general formulae (1a-ii) and (1b-ii) are reacted with

CH₂═CY—(CH₂)ₑ—SiX″ₙR¹₃₋ₙ, and T-H, or

CH₂═CY—(CH₂)ₑ—SiTₙR¹₃₋ₙ,

wherein: X″ is a halogen atom, and the other symbols are as defined above;

to obtain at least one compound of any one of the above general formulae (1a) and (1b).

For the fluorine-containing silane compound of the present invention represented by any one of the above general formulae (2a) and (2b), firstly, at least one compound of any one of the following general formulae (2a-i) and (2b-i) as a raw material:

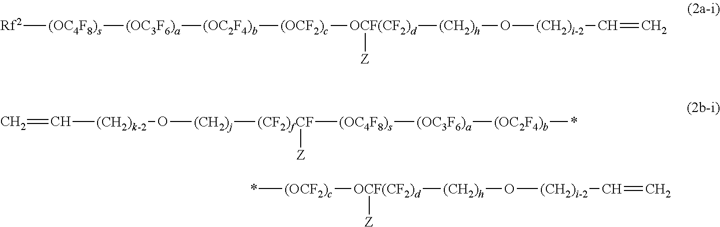

is subjected to hydrosilylation in the presence of a transition metal, preferably platinum or rhodium by using HSiXₙ¹R²₃₋ₙ, (wherein X¹ is a halogen atom, preferably chlorine atom, and the other symbols are as defined above) to obtain at least one compound of any one of the following general formulae (2a-ii) and (2b-ii).

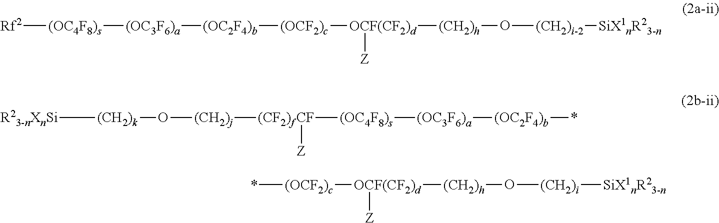

The at least one compound of any one of the above general formulae (2a) and (2b) is prepared by the dehalogenation of the at least one compound of any one of the general formulae (2a-ii) and (2b-ii) with TH (wherein T is as defined above, with the proviso that T is not a hydroxyl group).

Though the fluorine-containing silane compound of the present invention is described above, the fluorine-containing silane compound of the present invention is not limited to the compound prepared by the above example.

The compound of the present invention is useful in a surface-treating agent as described below, but not limited thereto, for example, the compound can be used in a lubricant or compatibilizing agent.

Surface-Treating Agent

A surface-treating agent of the present invention has only to comprise the above fluorine-containing silane compound of the present invention. That is, the surface-treating agent may comprise at least one or both of the fluorine-containing silane compound of the present invention of the above general formula (1a) and the fluorine-containing silane compound of the present invention of the above general formula (1b). When they are used in combination, the compound of the general formula (1a) and the compound of the general formula (1b) may be present, for example, at a ratio by weight of 10:1 to 1:1, but not limited thereto.

The surface-treating agent of the present invention may comprise at least one or both of the fluorine-containing silane compound of the present invention of the above general formula (2a) and the fluorine-containing silane compound of the present invention of the above general formula (2b). When they are used in combination, the compound of the general formula (2a) and the compound of the general formula (2b) may be present, for example, at a ratio by weight of 10:1 to 1:1, but not limited thereto.

Furthermore, the surface-treating agent of the present invention may comprise the fluorine-containing silane compounds of the present invention represented by the above general formulae (1a), (1b), (2a) and (2b) as one compound or a mixture of two or more. When the compounds are comprised as the mixture, each compound may be present at 1 to 99% by weight, preferably 10-90% by weight with respect to the total amount of the fluorine-containing silane compound of the present invention, but not limited thereto.

The surface-treating agent has only to comprise a fluorine-containing silane compound of the present invention as a main component or an active ingredient. The tem “main component” represents a component whose content in the surface-treating agent is more than 50% by weight. The term “active ingredient” represents a component which remains on a base material to be treated and forms a surface-treating layer and be able to provide some functions (water-repellency, oil-repellency, antifouling repellency, surface slip property, friction durability, or the like).

The surface-treating agent of the present invention comprises the fluorine-containing silane compound of the present invention, and can form a surface-treating layer having water-repellency, oil-repellency and antifouling repellency as well as high friction durability and surface slip property, therefore, can be suitably used as an antifouling-coating agent.

The composition of the surface-treating agent (or a surface-treating composition) of the present invention may appropriately be selected depending on functions which are required in the surface-treating layer.

The surface-treating agent of the present invention comprises a perfluoropolyether group containing silane compound which has a number average molecular weight of 1×10³ to 5×10³ and is represented by the above general formulae (1a), (1b), (2a) and/or (2b) in addition to the fluorine-containing silane compound of the present invention. When a fluorine-containing silane compound having a high molecular weight and a fluorine-containing silane compound having a low molecular weight are used in combination, superior friction durability can be obtained to when the fluorine-containing silane compound having a high molecular weight is used alone. When they are used in combination, a ratio by weight of the fluorine-containing silane compound of the present invention to the fluorine-containing silane compound having a number average molecular weight of 1×10³ to 5×10³ is 10:1 to 1:10, preferably 5:1 to 1:5, more preferably 1:1 to 1:2, but not limited thereto. The perfluoropolyether group containing silane compound which has a number average molecular weight of 1×10³ to 5×10³ has preferably a number average molecular weight of 2×10³ to 5×10³, more preferably about 4,000.

The surface-treating agent of the present invention may comprise a fluoropolyether compound which may be also understood as a fluorine-containing oil (hereinafter referred to as “a fluorine-containing oil” for the purpose of distinguishing from the fluorine-containing silane compound of the present invention), preferably a perfluoropolyether compound in addition to the fluorine-containing silane compound of the present invention. The fluorine-containing oil has no reactive part to the base (for example, a silyl group). The fluorine-containing oil contributes to increasing of surface slip property of the surface-treating layer.

The fluorine-containing oil may be contained in the surface-treating agent, for example, at 0-300 parts by weight, preferably 50-200 parts by weight with respect to 100 parts by weight of the perfluoropolyether group containing silane compound (as the total weight when two or more compounds are used; hereinafter the same shall apply).

Examples of the fluorine-containing oil include a compound of the following general formula (3) (a perfluoropolyether compound).

R²¹—(OC₄F₈)_{s′}—(OC₃F₆)_{a′}—(OC₂F₄)—(OCF₂)_{c′}—R²² (3)

In the formula:

R²¹ is an alkyl group having 1 to 16 carbon atoms which may be substituted by one or more fluorine atoms, preferably a straight or branched alkyl group having 1 to 3 carbon atoms which may be substituted by one or more fluorine atoms. The alkyl group which may be substituted by one or more fluorine atoms is preferably an alkyl group in which a terminal carbon atom is CF₂H— and the other carbons are fully-substituted with fluorine atoms or a perfluoroalkyl group, more preferably a perfluoroalkyl group.

R²² is a hydrogen atom, a fluorine atom or an alkyl group having 1 to 16 carbon atoms which may be substituted by one or more fluorine atoms, preferably a straight or branched alkyl group having 1 to 3 carbon atoms which may be substituted by one or more fluorine atoms. The alkyl group which may be substituted by one or more fluorine atoms is preferably an alkyl group in which a terminal carbon atom is CF₂H— and the other carbons are fully-substituted with fluorine atoms or a perfluoroalkyl group, more preferably a perfluoroalkyl group.

Subscripts a′, b′, c′ and s′ represent the repeating number of each of four repeating units of perfluoropolyether which constitute a main backbone of the polymer, and are each independently an integer from 0 to 300, for example an integer form 1 to 300 wherein the sum of a′, b′, c′ and s′ is at least 1, preferably 1-100. The occurrence order of the respective repeating units in parentheses with the subscript a′, b′, c′ or s° is not limited in the formulae. Among these repeating units, the —(OC₄F₈)— group may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF (C₂F₅)CF₂)— and —(OCF₂CF (C₂F₅))—, preferably —(OCF₂CF₂CF₂CF₂). The —(OC₃F₆)— group may be any of —(OCF₂CF₂CF₂)—, —(OCF(CF₃)CF₂)— and —(OCF₂CF(CF₃))—, preferably —(OCF₂CF₂CF₂)—. The —(OC₂F₄)— group may be any of —(OCF₂CF₂)— and —(OCF(CF₃))—, preferably —(OCF₂CF₂)—.

Examples of the perfluoropolyether compound of the above general formula (3) include a compound of any of the following general formulae (3a) and (3b) (may be one compound or a mixture of two or more compounds).

R²¹—(OCF₂CF₂CF₂)_{a″}—R²² (3a)

R²¹—(OCF₂CF₂CF₂CF₂)_{s″}—(OCF₂CF₂CF₂)_{a″}—(OCF₂CF₂)_{b″}—(OCF₂)_{c″}—R²² (3b)

In these formulae:

R²¹ and R²² are as defined above; in the formula (3a), a″ is an integer from 1 to 100; and in the formula (3b), b″ and c″ are each independently an integer from 1 to 300, and a″ and s″ are each independently an integer from 1 to 30. The occurrence order of the respective repeating units in parentheses with the subscript a″, b″, c″ or s″ is not limited in the formulae.

The compound of the general formula (3a) and the compound of the general formula (3b) may be used alone or in combination. When they are used in combination, preferably, the ratio by weight of the compound of the general formula (3a) to the compound of the general formula (3b) is 1:1 to 1:30. By applying such ratio by weight, a perfluoropolyether group-containing silane-based coating which has a good balance of surface slip property and friction durability can be obtained.

From the other point of view, the fluorine-containing oil may be a compound of the general formula: Rf¹—F (wherein, Rf¹ is as defined above). The compound of Rf¹—F is preferable because the compound has high affinity for the compound of any of the above general formulae (1a), (1b), (2a) and (2b).

The fluorine-containing oil may have an average molecular weight of 1,000-30,000, more preferably 3,000-30,000. This can provide high surface slip property.

Furthermore, the surface-treating agent of the present invention may comprise a silicone compound which may be also understood as a silicone oil (hereinafter referred to as “a silicone oil”) in addition to the fluorine-containing silane compound of the present invention. The silicone oil contributes to increasing of surface slip property of the surface-treating layer.

The silicone oil may be contained in the surface-treating agent, for example, at 0-300 parts by weight, preferably 50-200 parts by weight with respect to 100 parts by weight of the perfluoropolyether group containing silane compound.

Examples of the silicone oil include, for example, a liner or cyclic silicone oil having 2,000 or less siloxane bonds. The liner silicone oil may be so-called a straight silicone oil and a modified silicon oil. Examples of the straight silicone oil include dimethylsilicone oil, methylphenylsilicone oil, and methylhydrogensilicone oil. Examples of the modified silicone oil include that which is obtained by modifying a straight silicone oil with alkyl, aralkyl, polyether, higher fatty acid ester, fluoroalkyl, amino, epoxy, carboxyl, alcohol, or the like. Examples of the cyclic silicone oil include, for example, cyclic dimethylsiloxane oil.

Article

Next, an article which is produced by using the surface-treating agent will be described. The article of the present invention comprises a base material and a layer (surface-treating layer) which is formed from the fluorine-containing silane compound or the surface-treating agent of the present invention (hereinafter, referred to simply as “surface-treating agent” as a representative thereof) on the surface of the base material. This article can be produced, for example, as follows.

Firstly, the base material is provided. The base material usable in the present invention may be composed of any suitable material such as a glass, a resin (may be a natural or synthetic resin such as a common plastic material, and may be in form of a plate, a film, or others), a metal (may be a simple substance of a metal such as aluminum, copper, or iron, or a complex such as alloy or the like), a ceramic, a semiconductor (silicon, germanium, or the like), a fiber (a fabric, a non-woven fabric, or the like), a fur, a leather, a wood, a pottery, a stone, or the like.

For example, when an article to be produced is an optical member, a material constituting the surface of the base material may be a material for an optical member, for example, a glass or a transparent plastic. For example, when an article to be produced is an optical member, any layer (or film) such as a hard coating layer or an antireflection layer may be formed on the surface (outermost layer) of the base material. As the antireflection layer, either a single antireflection layer or a multi antireflection layer may be used. Examples of an inorganic material usable in the antireflection layer include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, WO₃, and the like. These inorganic materials may be used alone or in combination with two or more (for example, as a mixture). When multi antireflection layer is formed, preferably, SiO₂ and/or SiO are used in the outermost layer. When an article to be produced is an optical glass part for a touch panel, it may have a transparent electrode, for example, a thin layer comprising indium tin oxide (ITO), indium zinc oxide, or the like on a part of the surface of the base material (glass). Furthermore, the base material may have an insulating layer, an adhesive layer, a protecting layer, a decorated frame layer (I-CON), an atomizing layer, a hard coating layer, a polarizing film, a phase difference film, a liquid crystal display module, and the like, depending on its specific specification.

The shape of the base material is not specifically limited. The region of the surface of the base material on which the surface-treating layer should be formed may be at least a part of the surface of the base material, and may be appropriately determined depending on use, the specific specification, and the like of the article to be produced.

The base material may be that of which at least the surface consists of a material originally having a hydroxyl group. Examples of such material include a glass, in addition, a metal on which a natural oxidized film or a thermal oxidized film is formed (in particular, a base metal), a ceramic, a semiconductor, and the like. Alternatively, as in a resin, when the hydroxyl groups are present but not sufficient, or when the hydroxyl group is originally absent, the hydroxyl group can be introduced on the surface of the base material, or the number of the hydroxyl group can be increased by subjecting the base material to any pretreatment. Examples of the pretreatment include a plasma treatment (for example, corona discharge) or an ion beam irradiation. The plasma treatment may be suitably used to introduce the hydroxyl group into or increase it on the surface of the base material, further, to clarify the surface of the base material (remove foreign materials, and the like). Alternatively, other examples of the pretreatment include a method wherein a monolayer of a surface adsorbent having a carbon-carbon unsaturated bond group is formed on the surface of the base material by using a LB method (Langmuir-Blodgett method) or a chemical adsorption method beforehand, and then, cleaving the unsaturated bond under an atmosphere of oxygen and nitrogen.

Alternatively, the base material may be that of which at least the surface consists of a material comprising other reactive group such as a silicon compound having one or more Si—H groups or alkoxysilane.

Next, the film of the above surface-treating agent is formed on the surface of the base material, and the film is post-treated, as necessary, and thereby the surface-treating layer is formed from the surface-treating agent.

The formation of the film of the surface-treating agent can be performed by applying the above surface-treating agent on the surface of the base material such that the surface-treating agent coats the surface. The method of coating is not specifically limited. For example, a wet coating method or a dry coating method can be used.

Examples of the wet coating method include dip coating, spin coating, flow coating, spray coating, roll coating, gravure coating, and a similar method.

Examples of the dry coating method include vacuum deposition, sputtering, CVD and a similar method. The specific examples of the vacuum deposition method include resistance heating, electron beam, high-frequency heating, ion beam, and a similar method. The specific examples of the CVD method include plasma-CVD, optical CVD, thermal CVD and a similar method. The deposition method is will be described below in more detail.

Additionally, coating can be performed by an atmospheric pressure plasma method.

When the wet coating method is used, the surface-treating agent is diluted with a solvent, and then it is applied to the surface of the base material. In view of stability of the surface-treating agent and volatile property of the solvent, the following solvents are preferably used: an aliphatic perfluorohydrocarbon having 5-12 carbon atoms (for example, perfluorohexane, perfluoromethylcyclohexane and perfluoro-1,3-dimethylcyclohexane); an aromatic polyfluorohydrocarbon (for example, bis(trifluoromethyl)benzene); an aliphatic polyfluorohydrocarbon; a hydrofluoroether (HFE) (for example, an alkyl perfluoroalkyl ether such as perfluoropropyl methyl ether (C₃F₇OCH₃), perfluorobutyl methyl ether (C₄F₉OCH₃), perfluorobutyl ethyl ether (C₄F₉OC₂H₅) and perfluorohexyl methyl ether (C₂F₅CF(OCH₃)C₃F₇) (the perfluoroalkyl group and the alkyl group may be liner or branched)), and the like. These solvents may be used alone or as a mixture of two or more. Among them, the hydrofluoroether is preferable, perfluorobutyl methyl ether (C₄F₉OCH₃) and/or perfluorobutyl ethyl ether (C₄F₉OC₂H₅) are particularly preferable.

The formation of the film is preferably performed so that the surface-treating agent is present together with a catalyst for hydrolysis and dehydration-condensation in the coating. Simply, when the wet coating method is used, after the surface-treating agent is diluted with a solvent, and just prior to applying it to the surface of the base material, the catalyst may be added to the diluted solution of the surface-treating agent. When the dry coating method is used, the surface-treating agent to which a catalyst has been added is used itself in vacuum deposition, or pellets may be used in the vacuum deposition, wherein the pellets is obtained by impregnating a porous metal such as iron or copper with the surface-treating agent to which the catalyst has been added.

As the catalyst, any suitable acid or base can be used. As the acid catalyst, for example, acetic acid, formic acid, trifluoroacetic acid, or the like can be used. As the base catalyst, for example, ammonia, an organic amine, or the like can be used.

Next, the film is post-treated as necessary. This post-treatment is, but not limited to, a treatment in which water supplying and dry heating are sequentially performed, in more particular, may be performed as follows.

After the film of the surface-treating agent is formed on the surface of the base material as mentioned above, water is supplied to this film (hereinafter, referred to as precursor coating). The method of supplying water may be, for example, a method using dew condensation due to the temperature difference between the precursor coating (and the base material) and ambient atmosphere or spraying of water vapor (steam), but not specifically limited thereto.

It is considered that, when water is supplied to the precursor coating, water acts on a substituted amino group bonded to Si present in the perfluoropolyether group containing silane compound (the hydrolyzable group bonded to Si present in the perfluoropolyether group containing silane compound, if any) in the surface-treating agent, thereby enabling rapid hydrolysis of the compound.

The supplying of water may be performed under an atmosphere, for example, at a temperature of zero to 500° C., preferably 100° C. or more and 300° C. or less. By supplying water at such temperature range, hydrolysis can proceed. The pressure at this time is not specifically limited but simply may be ambient pressure.

Then, the precursor coating is heated on the surface of the base material under a dry atmosphere over 60° C. The method of dry heating may be to place the precursor coating together with the base material in an atmosphere at a temperature over 60° C., preferably over 100° C., and for example, of 500° C. or less, preferably of 300° C. or less, and at unsaturated water vapor pressure, but not specifically limited thereto. The pressure at this time is not specifically limited but simply may be ambient pressure.

Under such atmosphere, between the fluorine-containing silane compound of the present inventions (and the perfluoropolyether group containing silane compounds having an average molecular weight of 1×10³-5×10³, if present), the groups bonding to Si after hydrolysis are rapidly dehydration-condensed with each other. Furthermore, between the compound and the base material, the group bonding to Si in the compound after hydrolysis and a reactive group present on the surface of the base material are rapidly reacted, and when the reactive group present on the surface of the base material is a hydroxyl group, dehydration-condensation is caused. It is noted that the fluorine-containing oil and/or the silicone oil becomes to exist between the compounds thus bonded. As the result, the bond between the fluorine-containing silane compounds of the present invention (and the perfluoropolyether group containing silane compounds having an average molecular weight of 1×10³-5×10³, if present) is formed, and the bond between the compound and the base material is formed. It is noted that if present, the fluorine-containing oil and/or the silicone oil is held or acquired by an affinity to the perfluoropolyether group containing silane compound (and the perfluoropolyether group containing silane compounds having an average molecular weight of 1×10³-5×10³, if present).

The above supplying of water and dry heating may be sequentially performed by using a superheated water vapor.

The superheated water vapor is a gas which is obtained by heating a saturated water vapor to a temperature over the boiling point, wherein the gas, under an ambient pressure, has become to have a unsaturated water vapor pressure by heating to a temperature over 100° C., generally of 500° C. or less, for example, of 300° C. or less, and over the boiling point. When the base material on which the precursor coating is formed is exposed to a superheated water vapor, firstly, due to the temperature difference between the superheated water vapor and the precursor coating of a relatively low temperature, dew condensation is generated on the surface of the precursor coating, thereby supplying water to the precursor coating. Presently, as the temperature difference between the superheated water vapor and the precursor coating decreases, water on the surface of the precursor coating is evaporated under the dry atmosphere of the superheated water vapor, and an amount of water on the surface of the precursor coating gradually decreases. During the amount of water on the surface of the precursor coating is decreasing, that is, during the precursor coating is under the dry atmosphere, the precursor coating on the surface of the base material contacts with the superheated water vapor, as a result, the precursor coating is heated to the temperature of the superheated water vapor (temperature over 100° C. under ambient pressure). Therefore, by using a superheated water vapor, supplying of water and dry heating are enabled to be sequentially carried out simply by exposing the base material on which the precursor coating is formed to a superheated water vapor.

As mentioned above, the post-treatment can be performed. It is noted that though the post-treatment may be performed in order to further increase friction durability, it is not essential in the producing of the article of the present invention. For example, after applying the surface-treating agent to the surface of the base material, it may be enough to only stand the base material.

As described above, the surface-treating layer derived from the film of the surface-treating agent is formed on the surface of the base material to produce the article of the present invention. The surface-treating layer thus formed has high surface slip property and high friction durability. Furthermore, this surface-treating layer may have water-repellency, oil-repellency, antifouling repellency (for example, preventing from adhering a fouling such as fingerprints), surface slip property (or lubricity, for example, wiping property of a fouling such as fingerprints and excellent tactile feeling in a finger), friction durability, thus may be suitably used as a functional thin film.

The article having the surface-treating layer thus obtained is not specifically limited to, but may be an optical member. Examples of the optical member include the followings: lens of glasses, or the like; a front surface protective plate, an antireflection plate, a polarizing plate, or an anti-glare plate on a display such as PDP and LCD; a touch panel sheet of an instrument such as a mobile phone or a personal digital assistance; a disk surface of an optical disk such as a Blu-ray disk, a DVD disk, a CD-R or MO; an optical fiber, and the like.

The thickness of the surface-treating layer is not specifically limited. For the optical member, the thickness of the surface-treating layer is within the range of 1-30 nm, preferably 1-15 nm, in view of optical performance, friction durability and antifouling property.

Hereinbefore, the article produced by using the surface-treating agent of the present invention is described in detail. It is noted that an application, a method for using or a method for producing the article are not limited to the above exemplification.

### EXAMPLES

The fluorine-containing silane compound of the present invention, the surface-treating agent of the present invention and the article of the present invention produced by using it will be described in detail through Examples, although the present invention is not limited to Examples. It is noted that in Examples, the occurrence order of the four repeating units (CF₂O), (CF₂CF₂O), (CF₇CF₂CF₂O) and (CF₂CF₂CF₂CF₂O) constituting perfluoroether of the polymer is not limited.

### Synthesizing Example 1

To a four necked flask of 200 mL provided with a reflux condenser, a thermometer and a stirrer, perfluoroether modified iodide (45 g) represented by an average composition: CF₃CF₂CF₂O(CF₂CF₂CF₂O)₄₃CF₂CF₂CF₂—I, m-xylenehexafluoride (45 g) and vinyltrichlorosilane (3.85 g) were added and stirred under a nitrogen streaming at a room temperature for 30 minutes. Then, di-tert-buthylperoxide (0.68 g) was added and warmed to 120° C. and stirred at this temperature for 12 hours. Then, a volatile content was evaporated under a reduced pressure to obtain the following perfluoropolyether group containing silane compound which had iodine at the terminal (46 g).

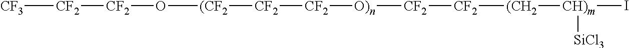

wherein, n is 43, and m is an integer of 1-6.

### Synthesizing Example 2

To a four necked flask of 200 mL provided with a reflux condenser, a thermometer and a stirrer, perfluoropolyether group containing silane compound which had iodine at the terminal prepared in Synthesizing Example 1, perfluorohexane (45 g), zinc powder (1.8 g) were added and stirred under a nitrogen streaming at 5° C. for 30 minutes. Then, methanol (20 g) was added dropwise at 5° C.-10° C., and then the mixture was warmed and mixed at 45° C. for 7 hours. Then, perfluorohexane (25 g) was added and stood. After a lower phase was separated, a volatile content was evaporated under a reduced pressure to obtain the following perfluoropolyether group containing silane compound (A) (40 g).

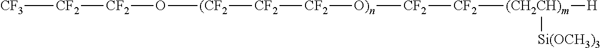

wherein, n is 43, and m is an integer of 1-6.

### Example 1

### Preparation of the Surface-Treating Agent

The compound of the following formula (A) (molecular weight: about 8,000; 20 parts by weight) and hydrofluoroether (Novec HFE 7200 (perfluorobutyl ethyl ether) manufactured by Sumitomo 3M Limited; 80 parts by weight) were mixed to prepare Surface-treating agent A.

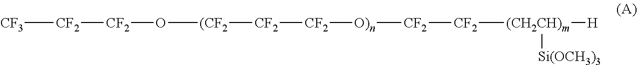

wherein, n is 43, and m is an integer of 1-6.

Base Material

A chemical strengthening glass (Gorilla glass manufactured by Corning Incorporated; thickness: 0.55 mm, flat dimension: 55 mm×100 mm) was used as a base material. No pretreatment of the base material was carried out.

Formation of the Surface-Treating Layer

Surface-treating agent A was used, and the surface-treating agent of 2 mg was vacuum-deposited (the treating condition, pressure: 3.0×10³ Pa) per one plate of glass and stood at 20° C. under an ambient of humidity of 65% for 24 hours to form a hardened coating. As the result, the surface-treating layer was formed on the surface of the base material.

### Example 2

The surface-treating layer was formed on the surface of the base material similarly to Example 1 except that the compound of the following formula (B) (molecular weight: about 8,000; 20 parts by weight) and hydrofluoroether (Novec HFE 7200 (perfluorobutyl ethyl ether) manufactured by Sumitomo 3M Limited; 80 parts by weight) were mixed to prepare Surface-treating agent B.

(CH₃O)₃—Si—CH₂CH₂CH₂—O—CH₂—CF₂—* *—O—(CF₂—CF₂—O—)ₚ—(CF₂—O—)_{q}—CF₂—CH₂—O—CH₂CH₂CH₂—Si—(OCH₃)₃ (B)

wherein, p is 40, and q is 40.

### Example 3

The surface-treating layer was formed on the surface of the base material similarly to Example 1 except that the compound of the following formula (C) (molecular weight: about 8,000; 20 parts by weight) and hydrofluoroether (Novec HFE 7200 (perfluorobutyl ethyl ether) manufactured by Sumitomo 3M Limited; 80 parts by weight) were mixed to prepare Surface-treating agent C.

CF₃—CF₂—CF₂—O—(CF₂—CF₂—CF₂—O—)ₙ—CF₂—CF₂—CH₂—O—CH₂CH₂CH₂—Si—(OCH₃)₃ (C)

wherein n is 45.

### Example 4

The surface-treating layer was formed on the surface of the base material similarly to Example 1 except that the compound of the following formula (A) shown in Example 1 (molecular weight: about 8,000; 6.6 parts by weight), the compound of the following formula (A) wherein n is 20 (molecular weight: about 4,000; 13.4 parts by weight) and hydrofluoroether (Novec HFE 7200 (perfluorobutyl ethyl ether) manufactured by Sumitomo 3M Limited; 80 parts by weight) were mixed to prepare Surface-treating agent D.

### Example 5

The surface-treating layer was formed on the surface of the base material similarly to Example 1 except that Compound (A) and the following perfluoroether compound (E) having a molecular weight of about 25,000 (FOMBLIN M60 manufactured by Solvay) were dissolved in hydrofluoroether (Novec HFE 7200 (perfluorobutyl ethyl ether) manufactured by Sumitomo 3M Limited) at a ratio by weight of 2:1 such that the concentration was 20 wt % (total concentration of Compound (A) and Compound (E)) to obtain the surface-treating agent.

Perfluoroether Compound (E)

CF₃O(CF₂CF₂O)₁₃₉(CF₂O)₁₂₂(CF₂CF₂CF₂O)₄(CF₂CF₂CF₂CF₂O)₄CF₃ (E)

### Example 6

The surface-treating layer was formed on the surface of the base material similarly to Example 1 except that Compound (A) and the above perfluoroether compound (E) having an average weight about 250,000 were dissolved in hydrofluoroether (Novec HFE 7200 (perfluorobutyl ethyl ether) manufactured by Sumitomo 3M Limited) at a ratio by weight of 1:1 such that the concentration was 20 wt % (total concentration of Compound (A) and Compound (E)) to obtain the surface-treating agent.

### Comparative Example 1

The surface-treating layer was formed on the surface of the base material similarly to Example 1 except that the compound of the above formula (A) wherein n is 20 and m is an integer of 1-6 having a molecular weight of about 4,000 was used in place of the compound having a molecular weight of about 8,000 used in Example 1

### Comparative Example 2

The surface-treating layer was formed on the surface of the base material similarly to Example 2 except that the compound of the above formula (B) wherein p is 20 and q is 20 having a molecular weight of about 4,000 was used in place of the compound having a molecular weight of about 8,000 used in Example 2.

### Comparative Example 3

The surface-treating layer was formed on the surface of the base material similarly to Example 3 except that the compound of the above formula (C) wherein n is 22 having a molecular weight of about 4,000 was used in place of the compound having a molecular weight of about 8,000 used in Example 3.

Evaluation

A static water contact angle of the surface-treating layers which were formed on the surface of the base material in the above Examples and Comparative Examples was measured. The static water contact angle was measured for 1 μL of water by using a contact angle measuring instrument (manufactured by KYOWA INTERFACE SCIENCE Co., Ltd.).

Firstly, as an initial evaluation, the static water contact angle of the surface-treating layer of which the surface had not still contacted with anything after formation thereof was measured (the friction number of times is zero).

Then, as an evaluation of the friction durability, a steel wool friction durability evaluation was performed. Specifically, the base material on which the surface-treating layer was formed was horizontally arranged, and then, a steel wool (grade No. 0000, dimensions: 5 mm×10 mm×10 mm) was contacted with the exposed surface of the surface-treating layer and a load of 1000 gf was applied thereon. Then, the steel wool was shuttled at a rate of 140 mm/second while applying the load. The static water contact angle (degree) was measured per 1,000 shuttling. The evaluation was stopped when the measured value of the contact angle became to be less than 100.

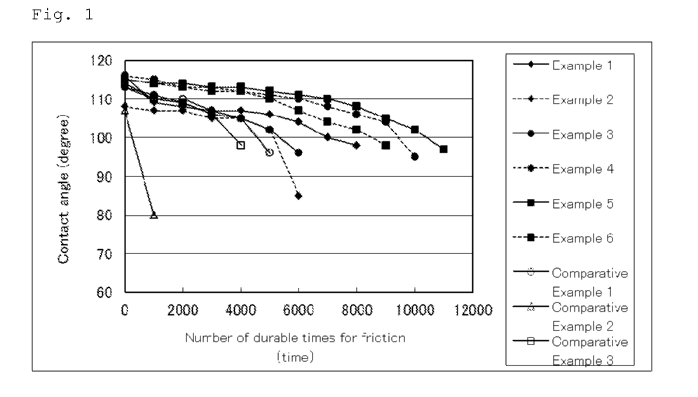

The results were shown in Table 1 (in the table, a symbol “-” means “not measured”) and FIG. 1.

TABLE 1

| Number of | | | | | | | | | |
|---|---|---|---|---|---|---|---|---|---|
| durable times | Contact angle (degree) | | | | | | | | |
| for friction | | Comparative | | Comparative | | Comparative | | | |
| (time) | Example 1 | Example 1 | Example 2 | Example 2 | Example 3 | Example 3 | Example 4 | Example 5 | Example 6 |
| 0 | 116 | 113 | 108 | 107 | 113 | 114 | 116 | 115 | 115 |
| 1000 | 109 | 110 | 107 | 80 | 111 | 110 | 115 | 114 | 114 |
| 2000 | 108 | 110 | 107 | — | 109 | 109 | 113 | 114 | 113 |
| 3000 | 107 | 107 | 105 | — | 106 | 106 | 113 | 113 | 112 |
| 4000 | 107 | 105 | 105 | — | 105 | 98 | 112 | 113 | 112 |
| 5000 | 106 | 96 | 102 | — | 102 | — | 111 | 112 | 110 |
| 6000 | 104 | — | 85 | — | 96 | — | 110 | 111 | 107 |
| 7000 | 100 | — | — | — | — | — | 108 | 110 | 104 |
| 8000 | 98 | — | — | — | — | — | 106 | 108 | 102 |
| 9000 | — | — | — | — | — | — | 104 | 105 | 98 |
| 10000 | — | — | — | — | — | — | 95 | 102 | — |
| 11000 | — | — | — | — | — | — | — | 97 | — |

As understood from Table 5 and FIG. 1, it was confirmed that Examples 1-3 using a fluorine-containing silane compound having a molecular weight of about 8,000 showed remarkably increased friction durability in comparison with Comparative Examples 1-3 using a fluorine-containing silane compound having a molecular weight of about 4,000. As understood from Example 4, Example 4 in which the fluorine-containing silane compound having a molecular weight of about 8,000 and the fluorine-containing silane compound having a molecular weight of about 4,000 were mixed was confirmed to show remarkably increased friction durability. Furthermore, as understood from Examples 5-6, Examples 5-6 in which the fluorine-containing silane compound having a molecular weight of about 8,000 and the fluorine-containing oil having a molecular weight of about 25,000 were mixed was confirmed to show remarkably increased friction durability.

### INDUSTRIAL APPLICABILITY

The present invention is suitably applied for forming a surface-treating layer on a surface of various base materials, in particular, an optical member in which transparency is required.

1. A perfluoropolyether group containing silane compound which has a number average molecular weight of 6×10³ to 1×10⁵ and is represented by any one of the following general formulae (1a) and (1b): 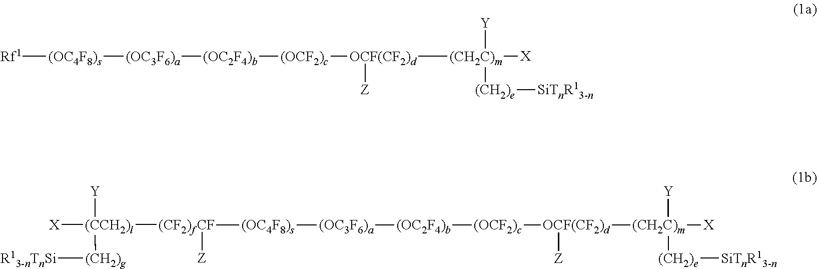
wherein:
Rf¹ is an alkyl group having 1 to 16 carbon atoms which may be substituted by one or more fluorine atoms;
a, b, c and s are each independently an integer of 0 or more and 200 or less, wherein the sum of a, b, c and s is 1 or more, and the occurrence order of the respective repeating units in parentheses with the subscript a, b, c or s is not limited in the formula;
d and f are 0 or 1;
e and g are an integer from 0 to 2;
m and l are an integer from 1 to 10;
X is a hydrogen atom or a halogen atom;
Y is a hydrogen atom or a lower alkyl group;
Z is a fluorine atom or a lower fluoroalkyl group;
T is a hydroxyl group or a hydrolyzable group;
R¹ is a hydrogen atom or an alkyl group having 1 to 22 carbon atoms; and
n is an integer from 1 to 3.

2. A perfluoropolyether group containing silane compound which has a number average molecular weight of 6×10³ to 1×10⁵ and is represented by any one of the following general formulae (2a) and (2b): 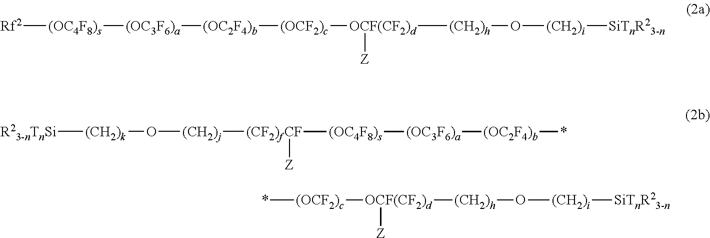
wherein:
Rf² is an alkyl group having 1 to 16 carbon atoms which may be substituted by one or more fluorine atoms;
a, b, c and s are each independently an integer of 0 or more and 200 or less, wherein the sum of a, b, c and s is 1 or more, and the occurrence order of the respective repeating units in parentheses with the subscript a, b, c or s is not limited in the formula;
d and f are 0 or 1;
h and j are 1 or 2;
i and k are an integer from 2 to 20;
Z is a fluorine atom or a lower fluoroalkyl group;
T is a hydroxyl group or a hydrolyzable group;
R² is a hydrogen atom or an alkyl group having 1 to 22 carbon atoms; and
n is an integer from 1 to 3.

3. The perfluoropolyether group containing silane compound according to claim 1 or claim 2 wherein the number average molecular weight is from 6×10³ to 3×10⁴.

4. A mixture of two or more perfluoropolyether group containing silane compounds according to claim 1 or claim 2.

5. A surface-treating agent comprising the perfluoropolyether group containing silane compound according to claim 1 or claim 2.

6. The surface-treating agent according to claim 5 which further comprises a perfluoropolyether group containing silane compound which has a number average molecular weight of 1×10³ to 5×10³ and is represented by any one of the following general formulae (1a), (1b), (2a) and (2b): 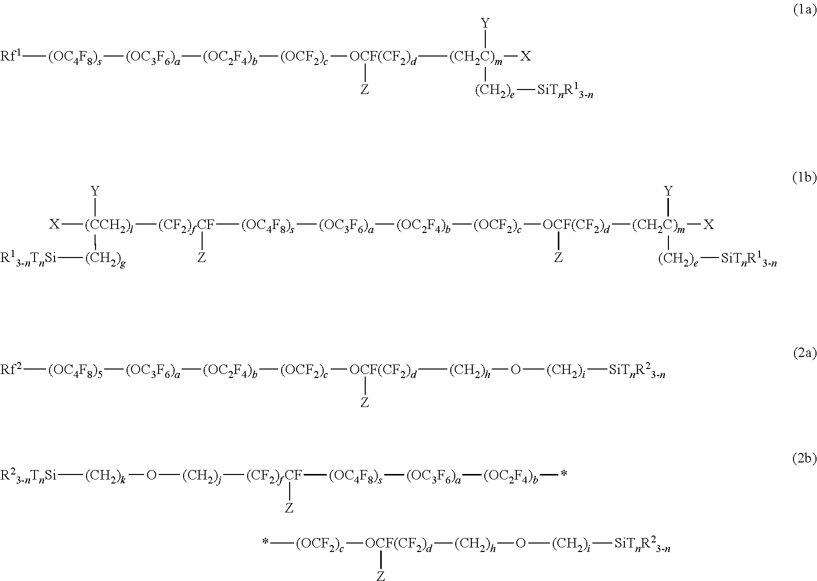
wherein:
Rf¹ and Rf² are an alkyl group having 1 to 16 carbon atoms which may be substituted by one or more fluorine atoms;
a, b, c and s are each independently an integer of 0 or more and 200 or less, wherein the sum of a, b, c and s is 1 or more, and the occurrence order of the respective repeating units in parentheses with the subscript a, b, c or s is not limited in the formula;
d and f are 0 or 1;
e and g are an integer from 0 to 2;
h and j are 1 or 2;
i and k are an integer from 2 to 20;
m and l are an integer from 1 to 10;
X is a hydrogen atom or a halogen atom;
Y is a hydrogen atom or a lower alkyl group;
Z is a fluorine atom or a lower fluoroalkyl group;
T is a hydroxyl group or a hydrolyzable group;
R¹ and R² are a hydrogen atom or an alkyl group having 1 to 22 carbon atoms; and
n is an integer from 1 to 3.

7. The surface-treating agent according to claim 5 which further comprises a fluorine-containing oil.

8. The surface-treating agent according to claim 7 wherein the fluorine-containing oil is a compound of the following general formula (3):
R²¹—(OC₄F₈)_{s′}—(OC₃F₆)_{a′}—(OC₂F₄)_{b′}—(OCF₂)_{c′}—R²² (3)
wherein:
R²¹ is an alkyl group having 1 to 16 carbon atoms which may be substituted by one or more fluorine atoms;
R²² is a hydrogen atom, a fluorine atom or an alkyl group having 1 to 16 carbon atoms which may be substituted by one or more fluorine atoms; and
a′, b′, c′ and s′ are each independently an integer of 0 or more and 300 or less, wherein the sum of a′, b′, c′ and s′ is 1 or more, and the occurrence order of the respective repeating units in parentheses with the subscript a′, b′, c′ and s′ is not limited in the formula.

9. The surface-treating agent according to claim 7 or claim g wherein the fluorine-containing oil is a compound of the following general formula (3b):
R²¹—(OCF₂CF₂CF₂CF₂)_{s″}—(OCF₂CF₂CF₂)_{a″}—(OCF₂CF₂)_{b″}—(OCF₂)_{c″}—R²² (3b)
wherein:
R²¹ is an alkyl group having 1 to 16 carbon atoms which may be substituted by one or more fluorine atoms;
R²² is a hydrogen atom, a fluorine atom or an alkyl group having 1 to 16 carbon atoms which may be substituted by one or more fluorine atoms; and
b″ and c″ are each independently an integer of 1 or more and 300 or less, and a″ and s″ are each independently an integer of 1 or more and 30 or less, and the occurrence order of the respective repeating units in parentheses with the subscript a″, b″, c″ or s″ is not limited in the formula.

10. The surface-treating agent according to claim 5 which is used as an antifouling-coating agent.

11. An article comprising a base material and a layer which is formed from the perfluoropolyether group containing silane compound according to claim 1.

12. The article according to claim 11 which is an optical member.

13. The article according to claim 11 wherein the base material is a glass or a transparent plastic.

14. An article comprising a base material of a layer which is formed from the surface-treating agent according to claim 5.

15. The article according to claim 14 which is an optical member.

16. The article according to claim 14 wherein the base material is a glass or a transparent plastic.
